(19) United States
(12) Patent Application Publication
(10) Pub. No.: US 2005/0189518 A1
(43) Pub. Date: Sep. 1, 2005

(54) Method of producing a fluorescent particle

(75) Inventor: Takami Arakawa, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/063,618

(22) Filed: Feb. 24, 2005

(30) Foreign Application Priority Data
Feb. 27, 2004 (JP) 2004-54316

(51) Int. Cl. C09K 11/08

(52) U.S. Cl. 252/301.6 S; 252/301.4 R

(57) ABSTRACT

A method of producing a fluorescent particle, which comprises sintering a raw fluorescent powder in the presence of a 40 wt % to 99.9 wt % flux to the total weight of said raw fluorescent powder and said flux; a fluorescent particle obtained by the above producing method; and an electroluminescence device, comprising the above fluorescent particle.

### FIELD OF THE INVENTION

The present invention relates to a fluorescent particle; in particular, to a dispersion-type electroluminescence fluorescent particle, and to a method of producing the same.

### BACKGROUND OF THE INVENTION

A dispersion-type electroluminescence device has a structure wherein a fluorescent layer, comprising a fluorescent particle dispersed in a binder having a high dielectric constant, is sandwiched between two electrodes, at least one of which is transparent, and the device emits light by applying an AC electric field between the two electrodes. A light-emitting device produced by use of an electroluminescence fluorescent particle has many advantages, as follows: The device can be made into a thickness of several millimeters or less; the device is a surface-emitting device, and the device generates only a small quantity of heat. The dispersion-type electroluminescence device has the following features: The device may be used to produce a flexible device having a plastic as its substrate, since the device can be produced without using any high temperature process; the device can be produced at low cost through a relatively simple process without using any vacuum apparatus; the luminous color of the device can be easily adjusted by mixing multiple kinds of fluorescent particles different in luminous color. Thus, the electroluminescence device is applied to various backlights. However, use of the dispersion-type electroluminescence device is limited to specified articles, such as backlights of portable telephones, since the device is insufficient in luminance and life.

The electroluminescence fluorescent particle is desired to give higher luminance, in order to enlarge the use scope thereof. As described in JP-A-2002-235080 (“JP-A” means unexamined published Japanese patent application), it is known that luminance is improved by classifying yielded fluorescent particles, and then selecting small particles therefrom. The reason luminance is improved is not necessarily clear, but the improvement appears to be based on an increase in the area of the surface for emitting light, by making the particles small.

To make the film thickness of a fluorescent layer small to heighten an electric field applied to the fluorescent layer; and, in order to heighten the density of the fluorescent particle filled into a coating film, it is preferred to make the size of the fluorescent particle small.

Conventional methods of producing an electroluminescence fluorescent particle are described in, for example, JP-A-8-183954 and JP-A-2000-136381. A raw fluorescent powder, which is usually called green powder, of size about 10 to 100 nm, is produced in a liquid phase manner, and this powder is used as a primary particle. An impurity called an activator is then mixed with this powder. A material called a “flux,” which has a melting point not higher than the sintering (firing) temperature, and a boiling point not lower than the sintering temperature, and which is present in the form of a liquid at the sintering temperature, is blended with the raw powder mixed with the activator, in such a manner that the amount of the flux becomes 10 to 20 wt %. The mixture is filled into a crucible, and then heated and sintered at 900 to 1300° C. for 30 minutes to 24 hours, thereby yielding a particle.

In such conventional sintering methods, the flux must be used in a larger amount (about 10 to 20 wt %) than in methods of producing a fluorescent substance for a CRT (cathode ray tube), or the like. By use of about 10 to 20 wt % of the flux, the particle size becomes large, resulting in particles in which a great number of low-luminance large particles are intermingled. Hitherto, therefore, an electroluminescence fluorescent substance made of a high-luminance small-particle has not been selectively obtained with ease.

As to a fluorescent particle wherein an electron is introduced into the luminescence center thereof by external excitation based on ultraviolet rays, electron beams, or the like, so as to emit light, such as a fluorescent particle for a CRT, it is known that the particle can be made small by the method of decreasing the amount of the flux therein, or the like. However, as to an electroluminescence fluorescent particle, it has been considered that an electric field concentrates into needle crystals of CuₓS present in the fluorescent particle, to generate electrons, and then the electrons are introduced into the luminescence center to emit light (see, for example, Fischer et al., Journal of the Electrochemical Society, Vol. 109, No. 11 (1962), 1043, and Fischer et al., Journal of the Electrochemical Society, Vol. 110, No. 7 (1962), 733). To precipitate needle crystals of CuxS in a fluorescent particle, it is necessary to incorporate, into the particle, Cu in a larger amount than the limit amount of Cu that can be dissolved therein. If the amount of the flux in raw materials is decreased, and the raw materials are sintered, the resultant particle becomes small. However, a sufficient amount of Cu cannot be introduced, since the amount of halogen as a co-activator becomes small. Thus, it is impossible to obtain an electroluminescence fluorescent particle having sufficient luminance.

It is also possible to use a material stable at a high temperature as a particle size depressor (controlling agent), without decreasing the amount of the flux, thereby producing a high-luminance electroluminescence fluorescent particle (see, for example, JP-A-11-193378). However, in this method, the number of washing operations to remove the particle size depressor made of fine particles becomes large. In addition, even if the washing is repeated many times, the particle size depressor is adsorbed on the surface of the fluorescent particle. Thus, it is difficult to remove the depressor completely.

An electroluminescence fluorescent particle is also desired to have a long life suitable for a variety of applications. It is known that, when the particle contains Au, as described in Japanese Patent No. 2994058; cesium, as described in JP-A-11-172245; antimony, as described in JP-A-2000-178551; or bismuth, as described in JP-A-2002-53854, the life is improved. However, even if any one of these elements is added to the particle, the life of the electroluminescence fluorescent substance is insufficient. Thus, a high-luminance fluorescent particle as described above has been desired to have a longer life.

### SUMMARY OF THE INVENTION

The present invention resides in a method of producing a fluorescent particle, which comprises sintering a raw fluorescent powder in the presence of a 40 wt % to 99.9 wt % flux to the total weight of said raw fluorescent powder and said flux.

Further, the present invention resides in a fluorescent particle obtained by the above producing method.

Further, the present invention resides in an electroluminescence device, comprising the above fluorescent particle.

Other and further features and advantages of the invention will appear more fully from the following description.

### DETAILED DESCRIPTION OF THE INVENTION

According to the present invention, there are provided the following means:
(1) A method of producing a fluorescent particle, which comprises sintering a raw fluorescent powder in the presence of a 40 wt % to 99.9 wt % flux to the total weight of said raw fluorescent powder and said flux;
(2) The method of producing a fluorescent particle according to the above item (1), wherein the flux is a halide;
(3) The method of producing a fluorescent particle according to the above item (1) or (2), wherein the flux mainly comprises a single material or a mixture of two or more materials selected from alkali metal halides, alkaline earth metal halides, ammonium halides, and mixed crystals of these halides;
(4) The method of producing a fluorescent particle according to any one of the above items (1) to (3), wherein the flux is made of a mixed material comprising strontium chloride and magnesium chloride;
(5) The method of producing a fluorescent particle according to any one of the above items (1) to (4), wherein the fluorescent particle is made of zinc sulfide comprising at least one element selected from the group consisting of copper, manganese, and rare earth elements;
(6) The method of producing a fluorescent particle according to the above item (5), wherein the fluorescent particle further comprises at least one element selected from the group consisting of chlorine, bromine, iodine, and aluminum;
(7) The method of producing a fluorescent particle according to the above item (5) or (6), wherein the fluorescent particle further comprises at least one element selected from the group consisting of gold, silver, bismuth, cesium, and antimony;
(8) The method of producing a fluorescent particle according to any one of the above items (1) to (7), comprising the steps of: sintering the raw fluorescent powder by use of the flux as a first sintering step, to prepare a fluorescent particle; applying impact to the fluorescent particle; and sintering the particle again as a second sintering step;
(9) A fluorescent particle obtained by the producing method according to any one of the above items (1) to (8);
(10) The fluorescent particle according to the above item (9), wherein the average particle diameter of the fluorescent particle is 20 μm or less;
(11) The fluorescent particle according to the above item (9) or (10), wherein the average particle diameter of the fluorescent particles is 15 μm or less;
(12) The fluorescent particle according to any one of the above items (9) to (11), wherein 30% or more (by number) of the fluorescent particle contain 10 or more layers each having a stacking fault at an interval of 5 nm or less;
(13) A dispersion-type electroluminescence device, comprising the fluorescent particle according to any one of the above items (9) to (12); and
(14) The electroluminescence device according to the above item (13), comprising a fluorescent layer containing the fluorescent particle, the thickness thereof being from 0.1 μm to 30 μm.

The present invention is described in detail below.

The fluorescent (phosphor) particle produced by the method of the present invention is specifically a semiconductor particle that is composed of one or more selected from the group consisting of elements of the II group and elements of the VI group, and/or one or more selected from the group consisting of elements of the III group and elements of the V group, and these elements may be selected arbitrarily in accordance with a required luminescence wavelength region. Herein, the II to VI groups are those in the periodic table of elements. Examples of these compounds include CdS, CdSe, CdTe, ZnS, ZnSe, ZnTe, CaS, MgS, SrS, GaP, GaAs, BaAl₂S₄, CaGa₂S₄, Ga₂O₃, Zn₂SiO₄, Zn₂GaO₄, ZnGa₂O₄, ZnGeO₃, ZnGeO₄, ZnAl₂O₄, CaGa₂O₄, CaGeO₃, Ca₂Ge₂O₇, CaO, Ga₂O₃, GeO₂, SrAl₂O₄, SrGa₂O₄, SrP₂O₇, MgGa₂O₄, Mg₂GeO₄, MgGeO₃, BaAl₂O₄, Ga₂Ge₂O₇, BeGa₂O₄, Y₂SiO₅, Y₂GeO₅, Y₂Ge₂O₇, Y₄GeO₈, Y₂O₃, Y₂O₂S, SnO₂, and mixed crystals of these compounds. Examples of the activator that can be used in the present invention include at least one element selected from the group consisting of copper, manganese, and rare earth elements. In the present invention, copper or manganese is preferably used. The fluorescent produced by the producing method of the present invention may comprise the activator alone, but it is preferable that the particle further comprises, as a co-activator, at least one selected from the group consisting of chlorine, bromine, iodine, and aluminum. In the present invention, the added amount of the activator is not particularly limited, and the total amount of the activator(s) is preferably from 0.01 to 1 wt %, more preferably from 0.05 to 0.5 wt %, to the raw fluorescent powder. In the case that the co-activator(s) is/are also used, the total amount of the co-activator(s) is preferably from 0.01 to 1 wt %, more preferably from 0.05 to 0.5 wt %, to the raw fluorescent powder.

In the method of producing a fluorescent particle of the present invention, a raw fluorescent powder, which is usually called green powder, having a particle diameter of about 1 nm to 1 μm is produced in a liquid phase method, and this powder is used as a primary particle. An impurity called an activator is then incorporated into this particle. The resultant, together with 40 wt % or more of the flux, is sintered in a crucible at a high temperature of 900 to 1300° C. for 30 minutes to 24 hours, thereby yielding a fluorescent particle.

In conventional methods of producing an electroluminescence fluorescent (phosphor) particle, the flux is used in an amount of about 10 to 20 wt %. Thus, these methods have a problem that the average particle diameter of the obtained particle becomes large. The present invention is characterized by using the flux in a larger amount (i.e. 40 wt % or more) than the amount used in conventional methods, whereby the average particle diameter of the obtained fluorescent particle can be made small. The amount of the flux is from 40 wt % to 99.9 wt %, thereby producing advantageous effects. The amount is preferably in the range of 50 wt % or more, which is a range making it possible to remarkably exhibit an advantageous effect for decreasing the particle diameter. The amount is preferably 80 wt % or less in order to increase the amount of the fluorescent substance obtained by one sintering operation. Herein, the ratio of the flux is represented by the following equation:
Flux ratio (wt %)=(Flux weight)/(Raw fluorescent primary particle weight+Flux weight)

In the case that copper, which is an activator, is beforehand added to the raw fluorescent powder, for example, in the case of the copper-activated zinc sulfide fluorescent substance described below, the copper as an activator is mixed with the raw fluorescent powder. In such a case, the weight of the raw fluorescent powder including copper is measured as the weight of the raw fluorescent powder.

The weight of the flux at room temperature may be different from that at the sintering temperature. For example, about barium chloride, it is present in the state of BaCl₂.2H₂O at room temperature. However, because hydrated water is lost therefrom at the sintering temperature, it is thought that barium chloride would be in the form of BaCl₂ at the sintering temperature. In this such a case, the ratio of the flux is calculated on the basis of the weight of the flux which is stable at room temperature.

The average particle diameter of the fluorescent particle obtained by the method of the present invention can be measured by a laser scattering method, in which a laser diffraction/scattering-type particle size distribution measurement device LA-920 (trade name) manufactured by Horiba, Ltd., or the like is used. The term “particle diameter” as used herein means a median size. According to the present invention, a high-luminance electroluminescence fluorescent particle having a small average particle diameter, which have not been hitherto produced with ease, can be easily produced. The average particle diameter of the fluorescent particle is preferably 20 μm or less, more preferably from 0.01 to 20 μm, and further preferably from 0.01 to 15 μm.

In the present invention, the flux is preferably made mainly of a halide; more preferably made mainly of a single material or a mixture of two or more materials selected from alkali metal halides, alkaline earth metal halides, and ammonium halides; and even more preferably made mainly of a mixed material comprising strontium chloride and magnesium chloride. The phrase “the flux is made mainly of a material” means that the flux comprises 80 wt % or more of the material.

The alkali metal halide includes, for example, lithium chloride, lithium bromide, lithium iodide, sodium chloride, sodium bromide, sodium iodide, potassium chloride, potassium bromide, potassium iodide, rubidium chloride, rubidium bromide, rubidium iodide, cesium chloride, cesium bromide, and cesium iodide.

The alkaline earth metal halide includes, for example, magnesium chloride, magnesium bromide, magnesium iodide, calcium chloride, calcium bromide, calcium iodide, strontium chloride, strontium bromide, strontium iodide, barium chloride, barium bromide, and barium iodide.

The ammonium halide includes, for example, ammonium chloride, ammonium bromide, and ammonium iodide.

As described in, for example, JP-A-11-193378, a material stable at a high temperature is used as a particle size depressor (controlling agent) to sinter the raw fluorescent powder therewith, whereby a smaller particle can be obtained. In this case, the weight of the particle size depressor is not considered for the ratio of the flux, and the ratio of the flux is defined as the ratio of the flux in the mixture of the raw fluorescent powder and the flux. However, in the method of the present invention, a small fluorescent particle can be produced even if such a particle size depressor is not used.

Even if the number of washing operations for removing the particle size depressor made of a fine particle is made large or a large number of washing operations is repeated, the particle size depressor may be adsorbed on the surface of the fluorescent particle, so that it is difficult to completely remove the depressor with ease, as described above. Therefore, the particle size depressor is preferably a material soluble in acid or alkali, more preferably magnesium oxide.

By such a method, a fluorescent particle can be obtained. In the case that the fluorescent particle does not give sufficient electroluminescence yet, the particle may be subjected to a further step. The step described above is called a first sintering step.

The intermediate fluorescent particle obtained by the first sintering step is repeatedly washed with ion exchange water, acid or alkali, so as to remove the flux and an excess of the activator and co-activator. In the case that the particle size depressor is used, the depressor is removed in the same way in this step.

Next, the resultant intermediate fluorescent powder is subjected to a second sintering step. In the second sintering step, a heating (annealing) is carried out at a lower temperature (i.e. 300 to 800° C.) than that in the first sintering step, for 30 minutes to 12 hours. By the two sintering steps, a large number of stacking faults are generated in the fluorescent particle. In order for the fluorescent particle to contain many stacking faults, it is preferred to select conditions for the first and second sintering steps appropriately.

The application of impact having a strength in some range to the sintered product obtained by the first sintering step makes it possible to largely increase the density of the stacking faults without breaking the particle. It is known that the electroluminescence luminance of the particle is improved by increasing the number of stacking faults therein. The method for applying the impact is preferably a method of causing the intermediate fluorescent particle to contact each other so as to be mixed by means of a shaker jet mill or the like, a method of blending spheres made of alumina or the like with the particle (i.e., ball mill method), a method of accelerating the particle so as to be caused to collide with each other (i.e., jet flow method), a method of applying ultrasonic waves to the particle, or a method of applying pressure to the fluorescent particle by rubber press, isostatic press, or the like. For example, in the case of the ball mill impact, a necessary impact can be obtained by the method in which alumina beads having a diameter of 0.5 mm are rotated at 100 rpm for 10 minutes to 12 hours.

In order to obtain electroluminescence with high luminance, it is preferable that 30% or more (by number) of the fluorescent particle contain 10 or more layers each having a stacking fault structure at an interval of 5 nm or less. It is more preferable that 50% or more (by number) of the fluorescent particle have the stacking fault structure, and it is further preferable that 75% or more (by number) of the fluorescent particle have the stacking fault structure.

The stacking faults inside the fluorescent particle can be quantitatively determined by observing it with a transmission electron microscope. Approximately 100 mg of the fluorescent particle the stacking faults of which are desired to be measured are suspended into a solvent, such as methanol, ethanol, or acetone; and the suspension is pulverized in a mortar for about 10 minutes. When the thus-obtained fragments of the fluorescent particle are observed with a transmission electron microscope, the fluorescent particle fragment having a stacking fault structure can be observed as a fragment having a streak. On the other hand, in the case of the particle having no stacking fault structure, a smooth surface having no structure is observed. In counting the number of the streaks, when the percentage of the fragments having 10 or more streaks at an interval of 5 nm or less is 50% or more (by number), 50% or more (by number) of the fluorescent particle can be regarded as a fluorescent particle containing 10 or more layers each having a stacking fault structure at an interval of 5 nm or less.

It is desired to use a transmission electron microscope having a high accelerating voltage, for example, about 400 kV at the time of the observation, since the particle can be observed with a high contrast. In the observation using the transmission electron microscope, it is essential that electrons are transmitted through a sample. It is, therefore, necessary that the fluorescent particle is pulverized into fragments having a thickness of 0.1 to 100 nm. It cannot be judged whether the fragments having a thickness of 100 nm or more are fragments having no stacking faults or fragments through which no electrons are transmitted. Thus, these fragments are unsuitable for being observed.

The fluorescent particle obtained via the second sintering step is etched with an acid such as HCl, to remove metal oxides and the like generated in the particle surface in the second sintering step. Furthermore, the activator compound (such as copper sulfide) adhering to the surface of the particle is washed with KCN and removed. Subsequently, the intermediate fluorescent substance is dried to yield an electroluminescence fluorescent particle.

It is preferable that the electroluminescence fluorescent substance yielded by the producing method of the present invention further comprises at least one element selected from the group consisting of gold, silver, bismuth, cesium, and antimony.

The content of the element(s) is preferably 1×10⁻³ to 1×10⁻¹ mol %, and more preferably 3×10⁻³ to 6×10⁻² mol %. The content of gold is preferably 1×10⁻³ to 5×10⁻² mol %, and more preferably 3×10⁻³ to 3×10⁻² mol %. The content of silver is preferably 1×10⁻³ to 6×10⁻² mol %, and more preferably 3×10⁻³ to 5×10⁻² mol %. The content of bismuth is preferably 1×10⁻³ to 5×10⁻² mol %, and more preferably 3×10⁻³ to 3×10⁻² mol %. The content of cesium is preferably 1×10⁻³ to 5×10⁻² mol %, and more preferably 3×10⁻³ to 3×10⁻² mol %. The content of antimony is preferably 1×10⁻³ to 5×10⁻² mol %, and more preferably 3×10⁻³ to 3×10⁻² mol %.

As described in Japanese Patent No. 2994058, it is known that in the case that an electroluminescence device contains gold, the life of the device is improved. However, the advantageous effect is insufficient, when gold is applied to, for example, a small fluorescent particle produced by use of a particle size depressor, as described in JP-A-11-193378. The present inventor has found out that when gold is applied to the electroluminescence fluorescent particle produced by the producing method of the present invention, the advantageous effect becomes remarkable so as to yield effectively a fluorescent particle giving high luminance and having long life, which have not been yielded by conventional methods of producing an electroluminescence fluorescent substance.

In addition, when a fluorescent particle contain cesium, as described in JP-A-11-172245; antimony, as described in JP-A-2000-178551; or bismuth, as described in JP-A-2002-53854, the life thereof is improved. However, these elements, as well as gold, exhibit remarkable effects in the electroluminescence fluorescent particle produced by the producing method of the present invention.

Gold is added by the method in which a gold compound, such as chloroauric acid, is added dropwise to a slurry prepared by suspending zinc sulfide green powder in water. Gold may be added before the first sintering step and/or before the second sintering step. Preferably, gold is added before the first sintering step.

In the same way as in other fluxes, cesium is introduced by mixing a cesium compound, such as cesium chloride, with a raw particle and then sintering the mixture. Cesium may be added before the first sintering step and/or before the second sintering step. Preferably, cesium is added before the first sintering step.

Bismuth or antimony is introduced by heating a single element thereof or a compound thereof, such as bismuth chloride or antimony chloride, together with the fluorescent substance. Since both of bismuth and antimony are elements having high volatility, they fly off easily if they are not sealed with a lid or the like. They can be introduced in the first sintering step and/or the second sintering step. However, because bismuth and antimony each have high volatility, it is preferable that bismuth or antimony is introduced by sealing a single element (or compound) of bismuth or antimony and the intermediate fluorescent particle into a quartz tube and then heating them.

The fluorescent particle preferably has, on the surface of the particle, a non-luminous shell layer. The formation of the shell layer is preferably conducted by a chemical method following the preparation of a semiconductor fine particle, which will be a core of the fluorescent particle. The thickness of the shell layers is preferably 0.01 μm or more, and more preferably 0.01 μm or more, but 1.0 μm or less.

The non-luminous shell layer can be made of an oxide, nitride, or oxide/nitride, or a substance that has the same composition as those formed on the host fluorescent particle but contains no luminescence center. The shell layer can also be formed by epitaxially growing, on the host fluorescent particle material, a substance which has a different composition from that of the particle.

Examples of available methods of forming the non-luminescent shell layer include a vapor phase method, such as a combination of fluidized oil surface evaporation with electron beam method, sputtering or resistance heating method, laser ablation method, CVD (chemical vapor deposition) method, or plasma CVD method; a liquid phase method, such as double decomposition method, sol-gel method, ultrasonic chemical method, a method by thermal decomposition reaction of a precursor, reversed micelle method, a combination method of any of these methods with high temperature sintering, hydrothermal synthesis method, urea melting method, and freezing drying method; and spray thermal decomposition method. Particularly, the hydrothermal synthesis method, the urea melting method and the spray thermal decomposition method, which can be preferably used for the formation of the fluorescent particle, are also preferable for the synthesis of the non-luminescent shell layer.

For example, in the case that the non-luminescent shell layer is formed on the surface of a zinc sulfide fluorescent particle by the hydrothermal synthesis method, the zinc sulfide fluorescent substance, which will be a core particle, is added to a solvent and suspended therein. In the same manner as in the case of forming the particle, a solution containing a metal ion, which will be a material of the non-luminescent shell layer, and, if necessary, an optional anion is added to a reactor from the outside thereof at a controlled flow rate in a prescribed time. By stirring the inside of the reactor sufficiently, the particle can freely be moved in the solvent and further the added ions diffuse in the solvent to permit homogeneous growth of the particle. Consequently, a non-luminous shell layer can be homogeneously formed on the surface of the core particle. If necessary, the thus-obtained particle is sintered, thereby synthesizing a zinc sulfide fluorescent particle having, on the surface thereof, the non-luminous shell layer.

Further, in the case of forming a non-luminescent shell layer on the surface of the zinc sulfide fluorescent particle by the urea melting method, the zinc sulfide fluorescent particle is added in a urea solution in which a metal salt that would be a material of the non-luminescent shell layer is dissolved and melted. Because zinc sulfide is insoluble in urea, the temperature of the solution is raised in the same manner as in the case of forming particles, to obtain a solid in which the zinc sulfide fluorescent substance and the non-luminescent shell layer material are homogeneously dispersed in a resin derived from urea. This solid is pulverized, and then sintered with heat-decomposing the resin in an electric furnace. The sintering atmosphere is selected from inert atmosphere, acidic atmosphere, reducing atmosphere, ammonia atmosphere and vacuum atmosphere, thereby zinc sulfide fluorescent particle having a non-luminescent shell layer composed of an oxide, sulfide or nitride on the surface can be synthesized.

Alternately, for example, in the case of forming a non-luminescent shell layer on the surface of the zinc sulfide fluorescent particle by the spray thermal decomposition method, the zinc sulfide fluorescent particle is added in a solution in which a metal salt that would be a material of the non-luminescent shell layer is dissolved. This solution is atomized, and thermally decomposed, to form the non-luminescent shell layer on the surface of the zinc sulfide fluorescent particle. By appropriately selecting the atmosphere of the thermal decomposition and the atmosphere of an additional sintering, zinc sulfide fluorescent particle having a non-light-emitting shell layer composed of an oxide, sulfide or nitride on the surface can be synthesized.

When a dispersion-type electroluminescent device is produced by using the electroluminescence fluorescent particle prepared by the method of the present invention, the luminescent color is not particularly restricted. However, taking the application as a light source into consideration, preferably the luminescent color is a white color. As the method of outputting a white luminescent color, use can be preferably made, for example, of a method of using a fluorescent particle capable of self-emitting a white light such as zinc sulfide fluorescent particle activated with copper and manganese and gradually cooled after sintering, or a method of mixing two or more kinds of fluorescent particles capable of emitting three primary colors or complementary colors from each other. For example, a combination of blue, green and red, and a combination of bluish green and orange may be used, to obtain a white light. It is also preferable to use a method of making into a white color according to the steps of emitting a short-wavelength light such as blue, and then using a fluorescent pigment or a fluorescent dye, thereby to wavelength-convert (emit) a part of the emission to green and red, as described in JP-A-7-166161, JP-A-9-245511 and JP-A-2002-62530. Further, as CIE chromaticity coordinates (x, y), it is preferable that the value x is in the range of 0.30 to 0.43 and the value y is in the range of 0.27 to 0.41.

The structure itself of the dispersion-type electroluminescence device obtained by the method of the present invention may be any ordinary structure. Basically, the device has a structure wherein a fluorescent layer is sandwiched between a pair of electrodes that correspond to each other, at least one of which is transparent. It is preferable to insert a dielectric layer between the fluorescent layer and each of the electrodes so as to be adjacent thereto.

As a substrate of the dispersion-type electroluminescence device obtained by the method of the present invention, a glass substrate, a ceramic substrate, or a flexible transparent resin sheet can be used.

Those where the fluorescent particle is dispersed in a binder (dispersing agent) can be used for the luminescent layer. As a binder, a polymer having a relatively high dielectric constant, such as a cyanoethyl cellulose-series resin; polyethylene, polypropylene, or polystyrene-series resins, silicone resins, epoxy resins, resins of a vinylidene fluoride, or the like can be used.

The dielectric constant of the dielectric layer can be adjusted by properly mixing, for example, BaTiO₃ or SrTiO₃ fine particle having a high dielectric constant, into such a resin. It is possible to use a homogenizer, a planetary kneader, a roll kneader, an ultrasonic disperser, and the like, as a dispersing mean.

The dielectric layer may be made of any material that has a high dielectric constant, high insulating property, and a high dielectric breakdown voltage. The material can be selected from metal oxides and metal nitrides. Examples thereof include TiO₂, BaTiO₃, SrTiO₃, PbTiO₃, KNbO₃, PbNbO₃, Ta₂O₃, BaTa₂O₆, LiTaO₃, Y₂O₃, Al₂O₃, Zro₂, AION, and ZnS. Such a material may be provided as a homogeneous film or may be used as a film having grain structure.

The luminescent layer and the dielectric layer are preferably provided by an ordinary method, for example, a spin coating method, a dip coating method, a bar coating method, and a spray coating method. Among these, in particularly, it is preferable to use a method having a great variety of subjects to be printed such as a screen-printing method or a method of enabling continuous coating such as a slide coating method. For example, the screen-printing method is to coat, through a screen mesh, a dispersion of fluorescent substance or dielectric fine-particles dispersed in a polymer solution having a high dielectric constant. A film thickness can be controlled properly by regulating thickness and/or numerical aperture ratio of the mesh, and selecting the number of times in coating.

In order to heighten the luminance of the dispersion-type electroluminescence device, it is effective, as well as to improve the luminous efficiency of the fluorescent particle, to heighten an electric field applied to the fluorescent layer. To heighten the electric field applied to the fluorescent layer, the film thickness of the fluorescent layer is made thin, as well as a voltage applied to the device is made high. The film thickness of the fluorescent layer is preferably from 0.1 to 30 μm, more preferably from 0.5 to 30 μm, even more preferably from 0.5 to 25 μm. However, any device using a conventional electroluminescence fluorescent particle contains a great number of large particles. Therefore, it is difficult to set the film thickness of its fluorescent layer to 30 μm or less. According to the present invention, since the fluorescent particle can be made small, a fluorescent layer excellent in uniformity and thin-film-property can be formed in a film thickness of 30 μm or less. Therefore, when the same fluorescent particle and the same applying voltage as in the case using conventional techniques are used in the present invention, it is possible to produce a dispersion-type electroluminescence device giving a higher luminance according to the present invention.

Changing the dispersion to another one makes it possible to form not only a fluorescent layer and a dielectric layer, but also a backing electrode layer, and the like. In addition, to make into a large area can be easily attained by altering a screen size.

A method of preparing the dielectric layer may be a vapor phase method such as sputtering method and vacuum deposition. In this case, a thickness of the film is generally in the range of 0.1 μm or more and 10 μm or less.

In the EL device of the present invention, an electrode prepared by using any one of generally used transparent electrode materials is used as a transparent electrode. Examples of the transparent electrode material include oxides, such as ITO (indium tin oxide), ATO (antimony-doped tin oxide), ZTO (zinc-doped tin oxide), AZO (aluminum-doped zinc oxide), and GZO (gallium-doped zinc oxide); multi-layer structure films of silver thin film sandwiched between high-refractive-index layers; and π-conjugated-series polymers, such as polyanilines and polypyrroles. It is also preferable to arrange a tandem-type, grid-type, or the like type metal fine line on the transparent electrode, thereby to improve current-carrying performance.

The back electrode, which is present on the side from which light is not taken out, may be made of any material that has electric conductivity. The material is appropriately selected from metals such as gold, silver, platinum, copper, iron and aluminum; graphite, and other materials, considering the form of the device to be produced, the temperature in producing steps, and other factors. A transparent electrode made of ITO or the like may be used, as long as it has electric conductivity.

About the dispersion-type electroluminescence device, the luminance thereof becomes smaller by the effect of water content as the driving time thereof becomes longer. To prevent this, suggested are a method of sealing the device with a sealing film, as described in JP-A-2003-249349, a sealing film comprising poly(ethylene chloride trifluoride) resin, or the like; a method of adsorbing water content invading the inside of the device by using a desiccant, as described in JP-B-1-19756 (“JP-B” means examined Japanese patent publication); and the like. However, these methods are not necessarily sufficient for preventing the luminance of the electroluminescence device from decreasing by water content. The former method does not consider the invasion of water content from bonded portions of the device, and latter method does not consider the performance of any sealing film. In order to prevent the luminance of any electroluminescence device from decreasing as much as possible in a continuous driving thereof, it is necessary to prevent effectively and simultaneously the invasion of water content from the surface of the sealing film and the invasion of water content from the bonded surface of the sealing film. Thus, when the electroluminescence device is produced in the present invention, it is preferable to seal both surfaces of the device with, for example, a sealing film having a water vapor permeability of 0.05 g/m²/day or less at 40° C. and 90% RH, and further to arrange a desiccant layer at least between the electroluminescence device and the sealing film. The water vapor permeability of the sealing film is more preferably 0.01 g/m²/day or less.

According to the present invention, it is possible to provide an effective method of producing a small fluorescent particle giving high luminance, and to provide a dispersion-type electroluminescence device giving high luminance, wherein the fluorescent particle made small by the producing method is used.

In addition, according to the present invention, it is possible to provide an effective method of producing a small fluorescent particle giving high luminance and having a long life, and to provide a dispersion-type electroluminescence device giving high luminance and having a long life, wherein the fluorescent particle made small by the producing method is used.

The present invention will be described in more detail based on examples given below, but the invention is not meant to be limited by these.

### EXAMPLES

### Example 1

Water was added to 150 g of ZnS (manufactured by Furuuchi Chemical Corp., purity: 99.999%), to prepare a slurry. Thereto was added an aqueous solution containing 0.416 g of CuSO₄.5H₂O, to yield a ZnS green powder (average particle diameter: 100 nm), a portion of which was substituted with Cu. The Flux shown in Table 1 was mixed with the resultant green powder in the ratio shown in Table 1. The resultant mixtures were each filled into an aluminum crucible. In the case of the fluorescent substances 1 to 3 and the comparative examples 1 and 2, they were each sintered at 1200° C. for 4 hours. In the case of the fluorescent substances 4 to 9, they were each sintered at 1200° C. for 1 hour. Thus, fluorescent substance intermediates were yielded. The intermediates were washed with ion exchange water 10 times, and dried. The resultant intermediates were each annealed at 700° C. for 6 hours. The thus-obtained fluorescent particles were washed with a 10% KCN aqueous solution, so as to remove an excess of copper (copper sulfide) on the surface thereof, and then washed with water 5 times to yield electroluminescence fluorescent particles shown in Table 1.

The resultant fluorescent particles were used to produce devices as follows.

Each kind of the fluorescent particles yielded as described above was dispersed into a 30 wt % cyano resin CR—S (trade name, manufactured by Shin-Etsu Chemical Co., Ltd.) DMF (dimethylformamide) solution, and then this dispersion was applied onto a PET (poly(ethylene terephthalate)) base on which ITO was vapor-deposited, so as to have a film thickness of 50 μm. The resultant was dried at 80° C. for 4 hours. Thereafter, a barium titanate powder BT-02 (trade name, manufactured by Sakai Chemical Industry Co., Ltd.) was dispersed 30 wt % cyano resin solution similar to the above, and then this dispersion was applied onto the fluorescent layer and dried at 80° C. for 4 hours. Aluminum was vapor-deposited thereon, and then the luminance of the resultant was evaluated with a luminance meter BM-9 (trade name, manufactured by Topcom Co.). The particle diameter distribution was evaluated with a laser diffraction/scattering type particle-size measuring device LA-920 (trade name, manufactured by Horiba Ltd.). The results are shown in Table 1.

In the comparative example 1, the flux which had been frequently used in the production of an electroluminescence fluorescent substance hitherto was used. In the comparative example 2, the amount of the flux was decreased for the purpose of making the particle to be obtained small. In the comparative example 2, the obtained particles were certainly made small, but sufficient electroluminescence luminance was not obtained. On the other hand, in the fluorescent substance 1 according to the present invention, the flux was used in an amount about 6 times that in the comparative example 1. Therefore, the fluorescent substance 1 was made small, and further the EL intensity thereof was improved. In each of the fluorescent substances 2 to 9 according to the present invention, the flux was used in a large amount. In the fluorescent substances 2 to 9, the average particle diameter was decreased, and the electroluminescent luminance was improved. In particular, in the fluorescent substance 4 using the flux containing magnesium chloride and strontium chloride, the particles were most remarkably made small, and the electroluminescence luminance was most remarkably improved.

TABLE 1

| | ZnS | | | | | Relative |
|---|---|---|---|---|---|---|
| | green | | | Ratio of | Average particle | electroluminescence |
| | powder | Flux | | flux | diameter | luminance* |
| Fluorescent substance 1 (This invention) | 25.0 g | NaCl | 6.0 g | 64 wt % | 19 μm | 120 |
| | | BaCl₂.2H₂O | 12.6 g | | | |
| | | MgCl₂.6H₂O | 25.5 g | | | |
| Fluorescent substance 2 (This invention) | 25.0 g | NaCl | 32.7 g | 57 wt % | 15 μm | 116 |
| Fluorescent substance 3 (This invention) | 25.0 g | NaCl | 58.3 g | 70 wt % | 15 μm | 113 |
| Fluorescent substance 4 (This invention) | 25.0 g | BaCl₂.2H₂O | 4.2 g | 63 wt % | 14 μm | 130 |
| | | MgCl₂.6H₂O | 11.1 g | | | |
| | | SrCl₂.6H₂O | 27.3 g | | | |
| Fluorescent substance 5 (This invention) | 25.0 g | BaCl₂.2H₂O | 4.2 g | 54 wt % | 16 μm | 109 |
| | | MgCl₂.6H₂O | 8.5 g | | | |
| | | CsCl | 17.0 g | | | |
| Fluorescent substance 6 (This invention) | 25.0 g | BaCl₂.2H₂O | 4.2 g | 54 wt % | 18 μm | 104 |
| | | MgCl₂.6H₂O | 8.5 g | | | |
| | | KCl | 17.0 g | | | |
| Fluorescent substance 7 (This invention) | 25.0 g | BaCl₂.2H₂O | 4.2 g | 63 wt % | 15 μm | 120 |
| | | MgCl₂.6H₂O | 11.1 g | | | |
| | | SrCl₂.6H₂O | 27.3 g | | | |
| | | LiCl | 0.5 g | | | |
| Fluorescent substance 8 (This invention) | 25.0 g | BaCl₂.2H₂O | 4.2 g | 63 wt % | 15 μm | 118 |
| | | MgCl₂.6H₂O | 11.1 g | | | |
| | | SrCl₂.6H₂O | 27.3 g | | | |
| | | RbCl | 0.5 g | | | |
| Fluorescent substance 9 (This invention) | 25.0 g | BaCl₂.2H₂O | 4.2 g | 63 wt % | 15 μm | 122 |
| | | MgCl₂.6H₂O | 11.1 g | | | |
| | | SrCl₂.6H₂O | 27.3 g | | | |
| | | CaCl₂.6H₂O | 0.5 g | | | |
| Comparative example 1 | 25.0 g | NaCl | 1.0 g | 23 wt % | 25 μm | 100 |
| | | BaCl₂.2H₂O | 2.1 g | | | |
| | | MgCl₂.6H₂O | 4.25 g | | | |
| Comparative example 2 | 25.0 g | NaCl | 0.5 g | 13 wt % | 21 μm | 40 |
| | | BaCl₂.2H₂O | 1.05 g | | | |
| | | MgCl₂.6H₂O | 2.13 g | | | |

(Note)
*Relative electroluminescence luminance means a relative value of the electroluminescence luminance to that of the comparative example 1, when the electroluminescence luminance of the comparative example 1 was assumed to be 100. In the following examples, “relative electroluminescence luminance” has the same meaning as described above, unless otherwise specified.

### Example 2

Water was added to 150 g of ZnS (manufactured by Furuuchi Chemical Corp., purity: 99.999%), to prepare a slurry. Thereto were added 0.416 g of CuSO₄.5H₂O and HAuCl₄.4H₂O, the amount thereof being 1.3×10⁻² mol % of the amount of ZnS. Other steps were conducted in the same way as in Example 1, so as to produce a fluorescent substance 10 having the same composition as the fluorescent substance 4, except for the amount of Au; and a fluorescent substance of the comparative example 3 having the same composition as the fluorescent substance of the comparative example 1, except for the amount of Au. It was confirmed by ICP measurement that both of the fluorescent substance 10 and the comparative example 3 contained 1.0×10⁻² mol % of gold.

By use of each of four samples of the fluorescent substances 4 and 10 and the comparative examples 1 and 3, devices were produced by the following method.

A barium titanate powder BT-02 (trade name, manufactured by Sakai Chemical Industry Co., Ltd.) was dispersed in a 30 wt % cyano resin DMF solution, and then this dispersion was applied onto an aluminum sheet of 75 μm thickness, to form a dielectric layer having a thickness of 25 μm. The resultant was dried at 110° C. with a hot-wind drier for 6 hours.

Each kind of the above-mentioned fluorescent particles was dispersed into a 30 wt % cyano resin DMF solution, and then this dispersion was applied and laminated onto a transparent conductive film manufactured by Tob i Co., Ltd., to form a fluorescent layer having a thickness of 40 μm. The resultant was dried at 110° C. with a hot-wind drier for 6 hours.

The thus-produced aluminum sheet and transparent conductive film were stuck onto each other, so as to bring the dielectric layer into contact with the fluorescent layer. A heat roller of 150° C. temperature was used to compress the lamination thermally in vacuum.

Copper aluminum sheets each having a thickness of 80 μm were used to take out terminals for connecting to the outside, from the transparent electrode and the backing electrode of the above-mentioned device. Subsequently, the devices each were sandwiched between a water-absorbing sheet composed of two nylon-6 sheets and a moisture-proof film having two SiO₂ layers, and then thermally compressed and sealed.

The thus-obtained devices were continuously driven at 100 V and 1 kHz in a room-temperature (25° C.) and 60% humidity environment. As to the devices, the time when the luminance was reduced into a half of the initial luminance was obtained. As shown in Table 2 described below, in the case of both of the large particles and the small particles, the life of the devices was improved by use of gold. However, in the fluorescent substance obtained by the method of the present invention, this advantageous effect was more remarkable.

TABLE 2

| | | | | Relative |
|---|---|---|---|---|
| | | | | life |
| | | | Relative | (50% |
| | | Average | electrolumi- | reduction |
| | | particle | nescence | of lumi- |
| | Au amount | diameter | luminance | nance)** |
| Fluorescent | None | 14 μm | 130 | 90 |
| substance 4 | | | | |
| (This | | | | |
| invention) | | | | |
| Fluorescent | 1.0 × 10⁻² mol % | 14 μm | 126 | 300 |
| substance 10 | | | | |
| (This | | | | |
| invention) | | | | |
| Comparative | None | 25 μm | 100 | 100 |
| example 1 | | | | |
| Comparative | 1.0 × 10⁻² mol % | 25 μm | 104 | 110 |
| example 3 | | | | |

(Note)
**Relative life means a relative value of the life to that of the comparative example 1, when the life of the comparative example 1 was assumed to be 100. In the following examples, “relative life” has the same meaning as described above, unless otherwise specified.

### Example 3

A fluorescent substance 11 was produced in the same way as in the production of the fluorescent substance 4, except that not only 4.2 g of BaCl₂.2H₂O, 11.1 g of MgCl₂.6H₂O and 27.3 g of SrCl₂.6H₂O but also 5.0 g of CsCl were added to 25 g of ZnS green powder. The comparative example 4 was produced in the same way as in the comparative example 1, except that 5.0 g of CsCl was added, in addition to the flux used in the comparative example 1. The electroluminescence luminance and the relative life thereof were evaluated in the same way as in Example 2. The amount of Cs was evaluated by ICP. In the case of using Cs, both of the fluorescent substance 11 and the comparative example 4 each produced an effect of making the life longer than the fluorescent substance 4 and the comparative example 1. However, this effect was more remarkable in the electroluminescence fluorescent particle obtained by the method of the present invention.

TABLE 3

| | | | | Relative |
|---|---|---|---|---|
| | | | | life |
| | | | Relative | (50% |
| | | Average | electrolumi- | reduction |
| | | particle | nescence | of lumi- |
| | Cs amount | diameter | luminance | nance)** |
| Fluorescent | None | 14 μm | 130 | 90 |
| substance 4 | | | | |
| (This | | | | |
| invention) | | | | |
| Fluorescent | 9.0 × 10⁻³ mol % | 15 μm | 120 | 250 |
| substance 11 | | | | |
| (This | | | | |
| invention) | | | | |
| Comparative | None | 25 μm | 100 | 100 |
| example 1 | | | | |
| Comparative | 8.8 × 10⁻³ mol % | 26 μm | 95 | 110 |
| example 4 | | | | |

### Example 4

As to the fluorescent substance 4, the first sintering step was conducted in the same way as in Example 1. Thereafter, 20 g of the resultant fluorescent substance intermediate and 3 g of a bismuth powder (manufactured by Furuuchi Chemical Corp.) were put into a quartz tube, sealed in vacuum condition, and heated at 700° C. for 6 hours. Similarly, the resultant fluorescent substance intermediate and 3 g of an antimony powder (manufactured by Furuuchi Chemical Corp.) were put into a quartz tube, sealed in vacuum condition, and heated at 700° C. for 6 hours. Each kind of the resultant fluorescent particles was washed with a 10% KCN aqueous solution to remove an excess of copper (copper sulfide) on the surface thereof, and then washed with water 5 times. The fluorescent substance containing Bi and the fluorescent substance containing Sb were referred to as the fluorescent substance 12 and the fluorescent substance 13, respectively. A fluorescent substance which was produced in the same way but which neither contained Bi nor Sb was referred to as the fluorescent substance 14.

As to the comparative example 1, the first sintering step in the same way as in Example 1, and the resultant fluorescent substance intermediate was subjected to the same treatment as described above. The resultant fluorescent substance containing Bi and the fluorescent substance containing Sb were referred to as the comparative examples 5 and 6, respectively. The fluorescent substance produced without adding Bi or Sb was referred to as the comparative example 7.

In the case of using Bi or Sb, both of the fluorescent substances 12 and 13 and the comparative examples 5 and 6 each produced an effect of making the life longer than the fluorescent substance 14 and the comparative example 7. However, this effect was more remarkable in the electroluminescence fluorescent particles obtained by the method of the present invention.

TABLE 4

| | | | Average | Relative | Relative life |
|---|---|---|---|---|---|
| | Bi | Sb | particle | electroluminescence | (50% reduction |
| | amount | amount | diameter | luminance | of luminance) |
| Fluorescent | 1.1 × 10⁻² mol % | None | 14 μm | 134 | 250 |
| substance 12 | | | | | |
| (This invention) | | | | | |
| Comparative | 9.0 × 10⁻³ mol % | None | 25 μm | 103 | 130 |
| example 5 | | | | | |
| Fluorescent | None | 1.0 × 10⁻² mol % | 14 μm | 125 | 290 |
| substance 13 | | | | | |
| (This invention) | | | | | |
| Comparative | None | 9.0 × 10⁻³ mol % | 25 μm | 95 | 120 |
| example 6 | | | | | |
| Fluorescent | None | None | 14 μm | 130 | 80 |
| substance 14 | | | | | |
| (This invention) | | | | | |
| Comparative | None | None | 25 μm | 100 | 100 |
| example 7 | | | | (Standard) | (Standard) |

### Example 5

A fluorescence substance 15 was produced in the same way as in the fluorescent substance 1, except that a ball mill impacting step using alumina beads (wherein 50 g of alumina beads having a ball size (diameter) of 0.5 mm were mixed with 5 g of the fluorescent substance, and the mixture was milled for 20 minutes) was conducted after the first sintering step (sintering at 1200° C. for 4 hours) and before the second sintering step (annealing at 700° C. for 6 hours). An even higher electroluminescence luminance was given in the fluorescent substance 15, wherein the number of stacking faults of the fluorescent substance 1, the luminance of which was improved by making the particle small, was increased by the ball mill impact.

TABLE 5

| | | | Relative |
|---|---|---|---|
| | | Frequency of | electrolu- |
| | Ball mill | stacking | minescence |
| | impact | fault particles | luminance |
| Fluorescent substance 1 | None | 10% (by number) | 120 |
| (This invention) | | | |
| Fluorescent substance 15 | Present | 75% (by number) | 365 |
| (This invention) | | | |

### Example 6

The fluorescent substance 1 and the fluorescent substance of the comparative example 1 in Example 1 were each applied in the same manner as in Example 1, so as to form a fluorescent layer having a film thickness of 50 μm.

In addition, the same fluorescent substances were each applied so as to form a fluorescent layer having a thickness of 25 μm, which was a half of the above-mentioned thickness, and then the luminances thereof were compared.

In the case that the film thickness was 50 μm, all the fluorescent particle was able to be applied. However, when an attempt for applying the particle so as to be the film thickness of 25 μm was made, the fluorescent particle having a particle diameter of 25 μm or more was pulled with the applicator and could not be applied. Thus, the number of the applied fluorescent particles decreased. Since a large number of particles having 25 μm or more in the particle diameter was present in the fluorescent substance of the comparative example 1, the number of the applied particles deceased so that the luminance lowered. On the other hand, since almost all of the particle in the fluorescent substance obtained by the method of the present invention had a particle diameter of 25 μm or less, almost all of the fluorescent particle could be applied. In addition, the electric field applied to the fluorescent layer became larger by decrease in film thickness, when the same applying voltage was applied to the two kinds of the EL devices each having different film thickness of the fluorescent layer, so that the luminance thereof was made higher. The decrease in the particle diameter caused the particle itself to give a higher luminance, and further made it possible to thin the fluorescent film and make the luminance of the electroluminescence device still higher.

TABLE 6

| | | Relative |
|---|---|---|
| Film thickness of the | | electroluminescence |
| fluorescent layer | Used fluorescent substance | luminance |
| 50 μm | Fluorescent substance | 120 |
| | 1 (This invention) | |
| | Comparative example 1 | 100 |
| 25 μm | Fluorescent substance | 163 |
| | 1 (This invention) | |
| | Comparative example 1 | 71 |

Having described our invention as related to the present embodiments, it is our intention that the invention not be limited by any of the details of the description, unless otherwise specified, but rather be construed broadly within its spirit and scope as set out in the accompanying claims.

1. A method of producing a fluorescent particle, which comprises sintering a raw fluorescent powder in the presence of a 40 wt % to 99.9 wt % flux to the total weight of said raw fluorescent powder and said flux.

2. The method of producing a fluorescent particle according to claim 1, wherein the flux is a halide.

3. The method of producing a fluorescent particle according to claim 1, wherein the flux mainly comprises a single material or a mixture of two or more materials selected from alkali metal halides, alkaline earth metal halides, ammonium halides, and mixed crystals of these halides.

4. The method of producing a fluorescent particle according to claim 1, wherein the flux is made of a mixed material comprising strontium chloride and magnesium chloride.

5. The method of producing a fluorescent particle according to claim 1, wherein the fluorescent particle is made of zinc sulfide comprising at least one element selected from the group consisting of copper, manganese, and rare earth elements.

6. The method of producing a fluorescent particle according to claim 5, wherein the fluorescent particle further comprises at least one element selected from the group consisting of chlorine, bromine, iodine, and aluminum.

7. The method of producing a fluorescent particle according to claim 5, wherein the fluorescent particle further comprises at least one element selected from the group consisting of gold, silver, bismuth, cesium, and antimony.

8. The method of producing a fluorescent particle according to claim 1, comprising the steps of:
sintering the raw fluorescent powder by use of the flux as a first sintering step, to prepare a fluorescent particle;
applying impact to the fluorescent particle; and
sintering the particle again as a second sintering step.

9. A fluorescent particle obtained by the producing method according to claim 1.

10. The fluorescent particle according to claim 9, wherein the average particle diameter of the fluorescent particle is 20 μm or less.

11. The fluorescent particle according to claim 9, wherein the average particle diameter of the fluorescent particles is 15 μm or less.

12. The fluorescent particle according to claim 9, wherein 30% or more (by number) of the fluorescent particle contain 10 or more layers each having a stacking fault at an interval of 5 nm or less.

13. A dispersion-type electroluminescence device, comprising the fluorescent particle according to claim 9.

14. The electroluminescence device according to claim 13, comprising a fluorescent layer containing the fluorescent particle, the thickness thereof being from 0.1 μm to 30 μm.
